(19) United States
(12) Patent Application Publication
(10) Pub. No.: US 2026/0352015 A1
(43) Pub. Date: Nov. 5, 2026

(54) REGENERATIVE MULTI-PORT ENERGY STORAGE SYSTEM

(71) Applicant: Raytheon Company, Arlington, VA (US)

(72) Inventor: Stephen B. Kuznetsov, Marlborough, MA (US)

(21) Appl. No.: 19/195,827

(22) Filed: May 1, 2025

(51) Int. Cl. H02J 9/06; H02J 3/30; H02J 3/32; H02J 15/30

(52) U.S. Cl. CPC H02J 9/066; H02J 3/30; H02J 3/32; H02J 15/30

(57) ABSTRACT

A regenerative multi-port energy storage system includes an AC power supply that delivers AC power to a main input stator of a wound-field induction electrical machine. The system further includes a main rotor, an output stator, and a boost rotor. The main rotor is energized by an exciter power supply to generate a magnetic field which interacts with the main input stator to produce a first magnetic flux. The output stator is energized by a second magnetic flux generated from interaction between the energized main rotor and the output stator to generate an output stator current for driving an electrical load. The boost rotor is energized by the second magnetic flux to generate a boost current. A rotating current regulator regulates the boost current to generate a regeneration current and to inject the regeneration current into the main rotor to increase magnetic excitation and voltage of the output stator.

### BACKGROUND

The present disclosure generally relates to electrical power systems, and more particularly, to a regenerative multi-port energy storage system.

Hybrid Energy Storage Modules (HESMs) play a crucial role in addressing the limitations of traditional energy storage systems in high-power systems. By integrating multiple energy storage technologies such as supercapacitors, and flywheels, for example, HESMs provide rapid power delivery, fast recharge rates, and extended system longevity. This hybrid approach is essential for handling high-power pulsed loads. Unlike conventional electro-chemical batteries, which struggle with slow recharge rates and limited discharge cycles, HESMs can supply peak power instantly and recharge within seconds buffering recurrent power surges.

### SUMMARY

According to a non-limiting embodiment, a regenerative multi-port energy storage system comprises a main alternating current (AC) power supply configured to deliver medium-frequency AC power to a main input stator of a wound-field induction electrical machine, and an inertial energy storage device mechanically coupled to the electrical machine rotor. The method further comprises a main rotor, an output stator, and a boost rotor. The main rotor is electromagnetically coupled to the main input stator and is configured to be energized by an exciter power supply to generate a magnetic field that interacts with the main input stator to produce a first magnetic flux. The output stator is configured to be energized by a second magnetic flux generated from interaction between the energized main rotor and the output stator, and is configured to generate an output stator current which drives an electrical load in response to being energized. The boost rotor is magnetically coupled to the output stator and is configured to be energized by the second magnetic flux to generate a boost current in a boost rotor winding. The regenerative multi-port energy storage system comprises a main rotor, an output stator, an isolated stator, and a boost rotor. The main rotor is configured to be energized by an exciter power supply and to produce a magnetic field that interacts with the main input stator to generate a first magnetic flux. The output stator is configured to be energized by a second magnetic flux produced from interaction between the energized main rotor and the output stator, and is configured to generate an output stator current (Is2). The isolated stator is configured to be energized by a fourth magnetic flux produced by the main rotor and to generate a tertiary output current (Is3) that is electrically isolated from the output stator current (Is2). The boost rotor is magnetically coupled to the output stator and is configured to generate a boost current (Ir2) in a boost rotor winding (R2). The regenerative multi-port energy storage system further includes a rotating current regulator (RCR) and an inertial energy storage device. The RCR is configured to regulate the boost current (Ir2) to produce a regeneration current (Ir2′) that is injected into the main rotor to supplement a main exciter current (Ir1). The inertial energy storage device mechanically coupled to the electrical machine rotor. The regenerative multi-port energy storage system further includes a rotating current regulator (RCR) configured to regulate the boost current to generate a regeneration current and to inject the regeneration current into the main rotor to increase magnetic excitation and voltage of the output stator.

In addition to one or more of the features described above, or as an alternative to any of the foregoing embodiments, the main rotor includes a main rotor winding implemented as dual-windings comprising a first winding (R1a) and a second winding (R1b).

In addition to one or more of the features described above, or as an alternative to any of the foregoing embodiments, the rotating current regulator (RCR) is configured to inject the regeneration current into the second winding (R1b) of the main rotor.

In addition to one or more of the features described above, or as an alternative to any of the foregoing embodiments, the RCR comprises a three-phase rectifier-inverter power-semiconductor switching circuit configured to regulate a level and a frequency of the boost current.

In addition to one or more of the features described above, or as an alternative to any of the foregoing embodiments, the three-phase rectifier-inverter power-semiconductor switching circuit comprises a rectification stage, a DC-link filtering stage, and an inverter stage.

In addition to one or more of the features described above, or as an alternative to any of the foregoing embodiments, the inverter stage comprises a plurality of insulated-gate bipolar transistors (IGBTs) configured to operate in a pulse-width modulation (PWM) sequence to control a phase and frequency of the regeneration current.

In addition to one or more of the features described above, or as an alternative to any of the foregoing embodiments, a pulse forming network (PFN) configured to condition the DC output from the AC-to-DC converter to produce a flat-top or constant-current waveform for delivery to a high-power pulsed load.

According to another non-limiting embodiment, a regenerative multi-port energy storage system comprises a main rotor, an output stator, an isolated stator, and a boost rotor. The main rotor is configured to be energized by an exciter power supply and to produce a magnetic field that interacts with the main input stator to generate a first magnetic flux. The output stator is configured to be energized by a second magnetic flux produced from interaction between the energized main rotor and the output stator, and is configured to generate an output stator current (Is2). The boost rotor is magnetically coupled to the output stator whereby a third magnetic flux is generated by the magneto-motive-force of the output stator magnetic circuit and is configured to generate a boost current (Ir2) in a boost rotor winding (R2). The isolated stator is configured to be energized by a fourth magnetic flux produced by the main rotor and to generate a tertiary output current (Is3) that is electrically isolated from the output stator current (Is2). The regenerative multi-port energy storage system further includes a rotating current regulator (RCR) and an inertial energy storage device. The RCR is configured to regulate the boost current (Ir2) to produce a regeneration current (Ir2′) that is injected into the main rotor to supplement a main exciter current (Ir1). The inertial energy storage device mechanically coupled to the electrical machine rotor.

In addition to one or more of the features described above, or as an alternative to any of the foregoing embodiments, the system further comprises a first pulse forming network (PFN1) configured to receive the output stator current (Is2) and deliver a first pulsed output current (Io1); and a second pulse forming network (PFN2) configured to receive the tertiary output current (Is3) and deliver a second pulsed output current (Io3) that is electrically isolated from the first pulsed output current.

In addition to one or more of the features described above, or as an alternative to any of the foregoing embodiments, the main rotor includes a main rotor winding implemented as dual-windings comprising a first winding (R1a) and a second winding (R1b), and wherein the regeneration current (Ir2′) is injected into the second winding (R1b).

In addition to one or more of the features described above, or as an alternative to any of the foregoing embodiments, the RCR comprises a polyphase rectifier-inverter power-semiconductor switching circuit located on the rotor and configured to regulate a level and a frequency of the boost current (Ir2).

In addition to one or more of the features described above, or as an alternative to any of the foregoing embodiments, the three-phase rectifier-inverter power-semiconductor switching circuit includes a rectification stage, a DC-link filtering stage, and an inverter stage capable of regulating frequency, phase angle and amplitude of the regeneration current Ir2′.

In addition to one or more of the features described above, or as an alternative to any of the foregoing embodiments, the inverter stage comprises insulated-gate bipolar transistors (IGBTs) configured to operate in a pulse-width modulation (PWM) sequence to control a phase, amplitude and frequency of the regeneration current (Ir2′).

In addition to one or more of the features described above, or as an alternative to any of the foregoing embodiments, the output stator current (Is2) energizes the boost rotor and the boost rotor delivers the boost current (Ir2) to the RCR.

According to yet another non-limiting embodiment, a method of operating a multi-port energy storage system is provided. The method comprises delivering, from a main AC power supply, a medium-frequency alternating current (AC) power input to a main input stator of a wound-field induction electrical machine, and energizing a main rotor of the wound-field induction electrical machine using an exciter power supply to generate a magneto-motive force and develop a magnetic field that interacts with the main input stator to produce a first magnetic flux. The method further comprises generating a second magnetic flux from the interaction between the energized main rotor and an output stator of the induction electrical machine, the second magnetic flux energizing the output stator to generate a first output stator current; energizing a boost rotor magnetically coupled to the output stator using the third magnetic flux to induce a boost current in a boost rotor winding. The method further comprises generating, using a rotating current regulator (RCR), a regeneration current based on the boost current, injecting the regeneration current into the main rotor to increase magnetic excitation of the output stator, and energizing an isolated stator by a fourth magnetic flux generated by at least one rotor winding.

In addition to one or more of the features described above, or as an alternative to any of the foregoing embodiments, the method further comprises energizing the main rotor includes energizing a first rotor winding (R1a) included with the main rotor and a second rotor winding (R1b) included with the main rotor.

In addition to one or more of the features described above, or as an alternative to any of the foregoing embodiments, the method further comprises injecting the regeneration current which includes injecting the regeneration current into the second rotor winding (R1b).

In addition to one or more of the features described above, or as an alternative to any of the foregoing embodiments, the method further comprises powering a pulsed load using the isolated stator that includes an isolated stator winding (S3), the isolated stator winding (S3) utilizing a separate magnetic flux from the second rotor winding (R1b) to generate an output electrical power to a load a second output stator current independent of the first output stator current.

In addition to one or more of the features described above, or as an alternative to any of the foregoing embodiments, the method further comprises controlling a phase and frequency of the regeneration current to regulate the magnetic excitation of the output stator.

In addition to one or more of the features described above, or as an alternative to any of the foregoing embodiments, the method further comprises driving at least one stochastic or pulsed load using one or both of the output stator and the isolated stator

Additional technical features and benefits are realized through the techniques of the present disclosure. Embodiments and aspects of the present disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1A is a block diagram of a regenerative multi-port energy storage system according to a non-limiting embodiment of the present disclosure;

FIG. 1B is a graph depicting the output voltage with regeneration versus time of a conventional output stator compared to the output voltage without regeneration versus time of an output stator in response to receiving an injected regeneration current generated by the regenerative multi-port energy storage system according to a non-limiting embodiment of the present disclosure;

FIG. 2 is a block diagram of a HESM electrical machine implemented in the regenerative multi-port energy storage system according to a non-limiting embodiment of the present disclosure;

FIG. 3 is a schematic diagram of a power conditioning circuit configured to deliver the output current (Io) generated by the HESM electrical machine to pulsed loads according to a non-limiting embodiment of the present disclosure;

FIG. 4 is a block diagram of the rotor excitation and regenerative circuit included in the HESM electrical machine according to a non-limiting embodiment of the present disclosure;

FIG. 5 is a schematic diagram of an example three-phase rectifier-inverter IGBT circuit utilized in a rotating current regulator (RCR) according to a non-limiting embodiment of the present disclosure;

FIG. 6 is a block diagram illustrating the physical arrangement of a HESM electrical machine according to a non-limiting embodiment of the present disclosure;

FIG. 7 is a block diagram of a regenerative multi-port energy storage system according to another non-limiting embodiment of the present disclosure;

FIG. 8 is a block diagram of a HESM electrical machine implemented in the regenerative multi-port energy storage system according to another non-limiting embodiment of the present disclosure;

FIG. 9 is a block diagram illustrating the physical arrangement of a HESM electrical machine according to another non-limiting embodiment of the present disclosure;

FIG. 10A depicts a stator winding of a main or input stator according to a non-limiting embodiment of the present disclosure;

FIG. 10B depicts a stator winding of an output stator according to a non-limiting embodiment of the present disclosure;

FIG. 10C depicts a stator winding of an isolated output stator according to a non-limiting embodiment of the present disclosure;

FIG. 10D depicts a rotor winding of a main rotor according to a non-limiting embodiment of the present disclosure;

FIG. 10E depicts a rotor winding of a main rotor according to a non-limiting embodiment of the present disclosure;

FIG. 10F is a boost winding of a boost rotor according to a non-limiting embodiment of the present disclosure; and

FIG. 11 is a flow diagram illustrating a method of operating a multi-port energy storage system.

### DETAILED DESCRIPTION

Current high-power electrical systems face significant challenges due to the limitations of legacy energy storage technologies, particularly electro-chemical batteries. These storage devices cannot meet the high peak power demands (e.g., about 5000 kilowatts (kW)) of future highly pulsed loads, nor can they recharge fast enough (e.g., about 1.0 seconds to about 4.0 seconds) to support rapid pulsed power applications. State-of-the-art lithium batteries require over 30 seconds to recharge, making them unsuitable for these high-speed operations. Additionally, electro-chemical storage devices degrade quickly, with a lifespan of only about 5000 high-rate discharges, leading to increased maintenance and replacement costs.

Another issue arising from using high-power electrical systems, to produce high-current outputs for driving high-power/high-speed pulsed loads is the generation of excessive harmonics and electrical transients which can interfere with and even shut down other loads connected to the main power bus. Additionally, there is a critical mismatch between peak power demands (e.g., about 5000 kW) and the limited average power supply (e.g., about 2500 kW), necessitating sophisticated load-leveling solutions. Existing energy storage designs, however, lack effective buffering mechanisms to protect the main AC power system from repetitive surges and high-pulse-rate loads required when implementing state-of-the art high-power/high-speed pulsed loads, especially multiple high-power/high-speed pulsed loads, which can cause voltage instability and failures in other subsystems.

Various non-limiting embodiments of the present disclosure provide a regenerative multi-port energy storage system that implements compact rotating machinery and inertial storage to buffer the multiple high-power/high-speed pulsed loads requiring high-power input generated using a main AC power supply. The regenerative multi-port energy storage system also implements compact rotating machinery and inertial storage to buffer a main AC power supply from multiple high-power/high-speed pulsed loads and repetitive transient and power surges caused by high pulse rates of the loads.

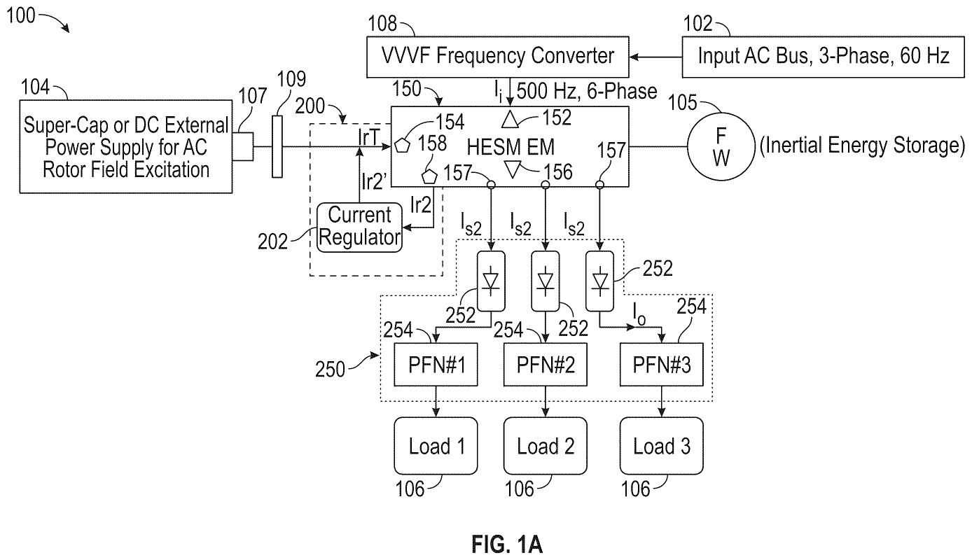

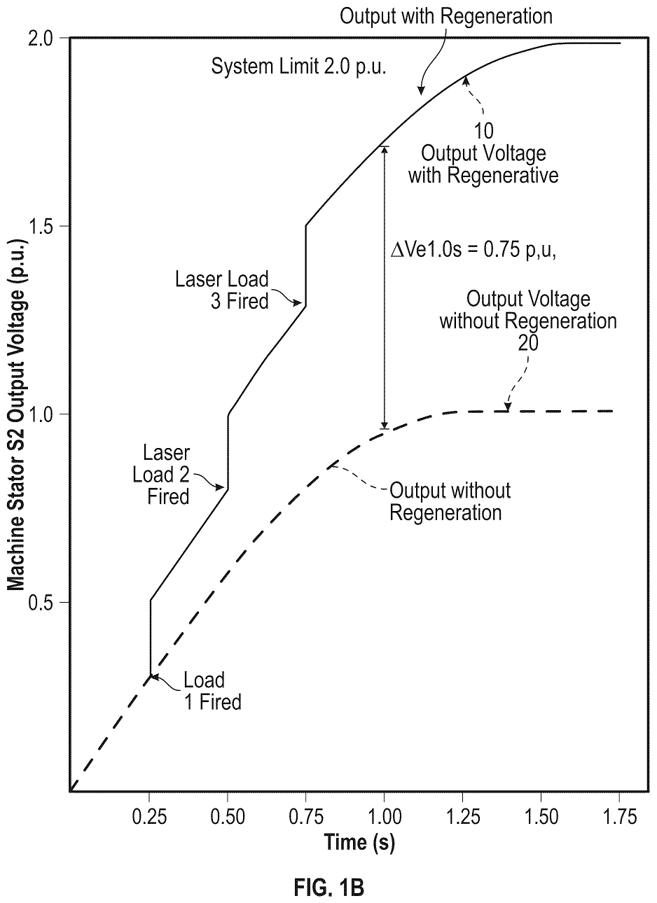

With reference now to FIG. 1A, a regenerative multi-port energy storage system 100 is illustrated according to a non-limiting embodiment of the present disclosure. The regenerative multi-port energy storage system 100 includes a main AC power supply 102, an exciter power supply 104, an HESM electrical machine 150, a regenerative circuit 200, a conditioning circuit network 250, and one or more pulsed loads 106. In a non-limiting embodiment, the pulsed loads 106 may differ. For example, a first load 106 can be implemented as a high-power, high-speed pulsed laser, while another load 106 is implemented as a radar system.

The main AC power supply 102 delivers multi-phase alternating current (AC) power at an operating frequency (e.g., 60 Hz) through a variable-voltage variable-frequency (VVVF) converter 108. The VVVF converter 108 increases the operating electrical frequency (e.g., to about 700 Hz) to achieve increased HESM operating shaft speeds.

The HESM electrical machine 150 operates at high speeds (e.g., ranging from about 5,000 RPM to greater than 20,000 RPM) and requires a higher frequency power source (e.g., around 700 Hz). The HESM electrical machine 150 can be implemented as a high-speed wound rotor induction machine, which includes a three-phase wound rotor instead of a permanent magnet configuration. The HESM electrical machine 150 includes a main input stator 152, a main rotor 154, and an output stator 156. The main input stator 152 is connected to the VVVF converter 108 to receive high frequency AC power. The main rotor 154 is connected to the exciter power supply 104 through a set of polyphase slip rings 109, which operates at a lower frequency (e.g., around 20-100 Hz) compared to the main AC power supply 102. When rotating, the energized main rotor 154 produces a first magnetic flux (φ1), a second magnetic flux (φ2), and a third magnetic flux (φ3).

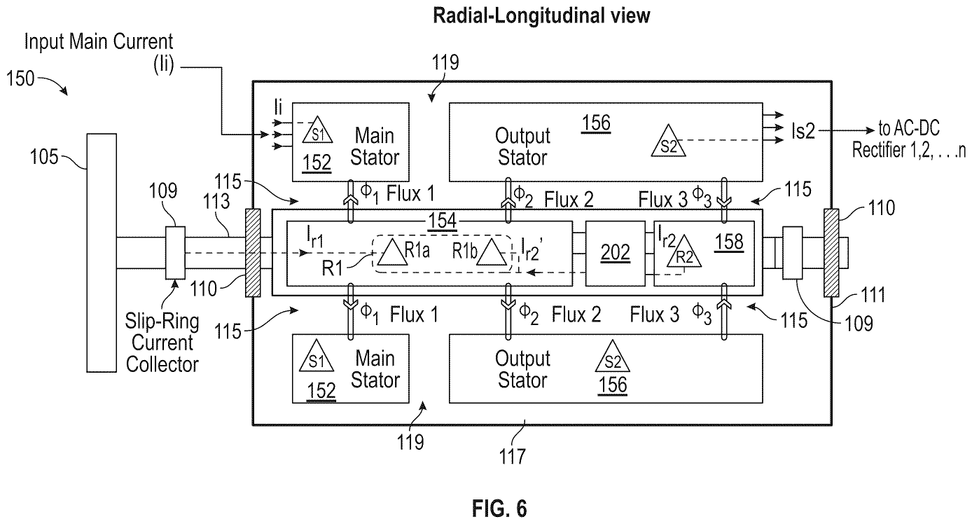

The output stator 156 is separated from the main input stator 152 by a second axial airgap 119 that extends perpendicular to the length of the shaft 113 (see FIG. 6). The output stator 156 generates an output stator current (Is2) in response to being energized by the second magnetic flux (φ2). The output stator 156 has one or more electrically isolated stator output ports 157. These stator output ports 157 output the output stator current (Is2), which can then be used to drive various independent loads, such as loads 106. The loads 106 include high-power, high switch-speed (high-power/high-speed) pulsed loads 106 including, but not limited to, pulsed lasers, radars, and other pulsed energy devices.

The regenerative circuit 200 provides a regeneration mechanism to enhance system efficiency and speed of response by utilizing a rotating current regulator (RCR) 202 and a separate rotor winding included in the HESM electrical machine referred to herein as a “boost rotor” 158. The boost rotor 158 is operable to collect a portion of the energy (e.g., magnetic flux) produced by the output stator 156. The regenerative circuit 200 utilizes the induced magnetic energy to generate a boost current (Ir2), which is phase regulated by the RCR 202 to produce a regeneration current (Ir2′) that is injected current back into the main rotor 154 to regenerate the second magnetic flux (φ2) which magnetizes and controls the output stator 156. Accordingly, the regenerative circuit 200 operates as a “booster” to enhance the operation of the HESM electrical machine 150 and optimize its performance and speed of response.

The conditioning circuit network 250 includes AC-to-DC converters 252 connected to corresponding pulse forming networks (PFNs) 254. Each AC-to-DC converter 252 can be implemented as a full-wave rectifier bridge. The full-wave rectifier bridge can be implemented using diodes (e.g., six diodes) or IGBT devices, for example.

The pulse forming network (PFN) 254 functions as a passive current conditioning system, which sharpens pulses and shapes the output waveform of the output current (Io). For example, each PFN 254 conditions the output current (Io) to generate a flat-top DC waveform capable of driving high-power/high-speed loads, such as loads 106. In a non-limiting embodiment, the DC waveform includes a controlled rise time and remains stable between a set time period, aligning with the operational periods of high-power/high-speed loads 106 such as, for example, pulsed lasers and radars. After a defined fall time, the waveform drops to zero before the enter a resting phase, followed by another pulse cycle.

The graph shown in FIG. 1B depicts the output voltage with regeneration versus time of a conventional output stator compared to the output voltage without regeneration of the output stator 156 in response to receiving the injected regeneration current (Ir2′) according to a non-limiting embodiment of the present disclosure. The lower curve 10 represents the performance of the conventional stator, which gradually increases output voltage but remains limited by basic excitation. The upper curve 20 shows the output voltage ramp-up speed of the output stator 156 in response to the injected regeneration current (Ir2′). The regenerative multi-port energy storage system 100 uses the output stator current (Is2) to generate the regeneration current (Ir2′), which is injected into the boost rotor 158 to boost its rotor winding excitation in discrete steps. For example, at 1.0 second into the firing mission, the output stator 156 achieves 1.70 per unit (pu) volts (V), while the conventional output stator reaches only 0.95 pu V. By the end of the cycle or 1.75 second in example shown, the regenerative excitation produces the system limit of 2.0 pu V (1200 volts rms AC), compared to just 1.05 pu V with basic excitation (e.g., non-regeneration excitation) used with the conventional output stator.

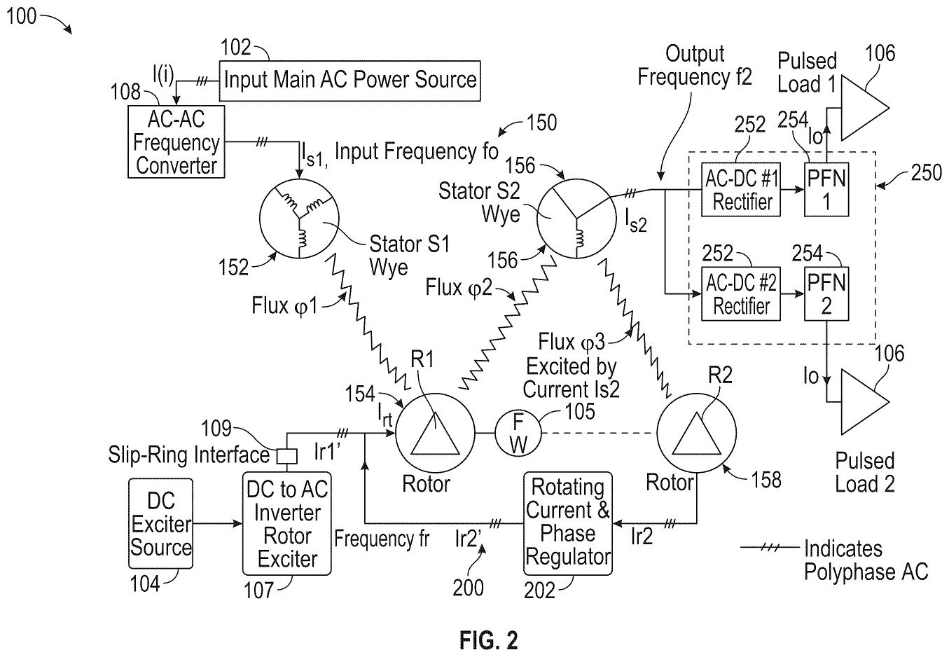

Turning now to FIG. 2, a schematic diagram of a HESM electrical machine 150 implemented in the regenerative multi-port energy storage system 100 is illustrated according to a non-limiting embodiment of the present disclosure. As described above, the HESM electrical machine 150 includes a main input stator 152, a main rotor 154, an output stator 156, and a boost rotor 158. The main input stator 152 and the main rotor 154 include a main input stator winding (S1) and main rotor winding (R1), respectively. Likewise, the output stator 156 and the boost rotor 158 include an output stator winding (S2) and a boost rotor winding (R2), respectively.

Main AC power generated by the main AC power supply 102 is delivered to the AC-AC frequency converter 108, which increases the frequency (e.g., to approximately 700 Hz) before inputting main power to the main input stator 152. The main input stator winding (S1) serves as the motoring or input winding and generates the main input stator flux, i.e., the first magnetic flux (φ1), in response to receiving input main current (Is1) delivered from the AC-AC frequency converter 108.

The main rotor 154 is electromagnetically coupled with the exciter power supply 104. In a non-limiting embodiment, the exciter power supply 104 implements a DC-to-AC polyphase converter 107, which draws power from an independent energy source, such as a battery or a high-voltage DC bus (e.g., 1000 V), and converts the DC power into AC exciter power used to energize the main rotor 154. In a non-limiting embodiment, the exciter power supply 104 operates in conjunction with a flywheel 105, which serves as an inertial energy storage device for providing energy that is converted by the combination of the exciter power supply 104 into useable output energy of the output stator 156.

In a non-limiting embodiment, the main rotor 154 implements the main rotor winding (R1) as dual-windings (R1a, R1b), such as three-phase bifilar delta windings (R1a, R1b). The dual-winding (R1a, R1b) commonly occupy the main rotor 154, but are separated from one along the axis of the main rotor 154.

The energized main rotor 154 generates a first rotor flux (φ1r), in response to receiving an exciter current (Ir1) output from the exciter power supply 104. The first rotor flux (φ1r) is combined with the main input stator flux (φ1) to produce a total flux (φ1). The interaction between the energized main rotor 154 and the output stator 156 also produces the second magnetic flux (φ2), e.g., via the dual-winding, which energizes the output stator winding (S2) of the output stator 156. The energized output stator winding (S2) induces current flow (Is2) therethrough, which produces the third magnetic flux (φ3). The current flow (Is2) is utilized to generate an output DC current (Ix), which is delivered to the pulse forming network (PFN) 254.

The boost rotor winding (R2) of the boost rotor 158 is magnetically coupled to the output stator 156 and injects current/power into the regenerative circuit 200. The third magnetic flux (φ3) produced from the output stator winding (S2) energizes the boost rotor winding (R2) to induce the polyphase boost current (Ir2). The boost rotor 158 delivers the boost current (Ir2) to the regenerative circuit 200, which includes an inverter (not shown) to control the current level and frequency of the boost current (Ir2). The output of the regenerative circuit 200 is a regulated current referred to as a “regeneration current” (Ir2′), which is then injected back into the main rotor 154 to facilitate flux regeneration. Accordingly, the regenerative circuit receives polyphase current from the boost rotor winding (R2), rectifies and conditions it (e.g., using an IGBT inverter stage), and injects the phase-controlled regeneration current (Ir2′) back into the main rotor winding (R1). This regeneration mechanism accelerates flux (φ2)buildup, enabling efficient recirculation of energy derived from the output stator flux, i.e., the third magnetic flux (φ3).

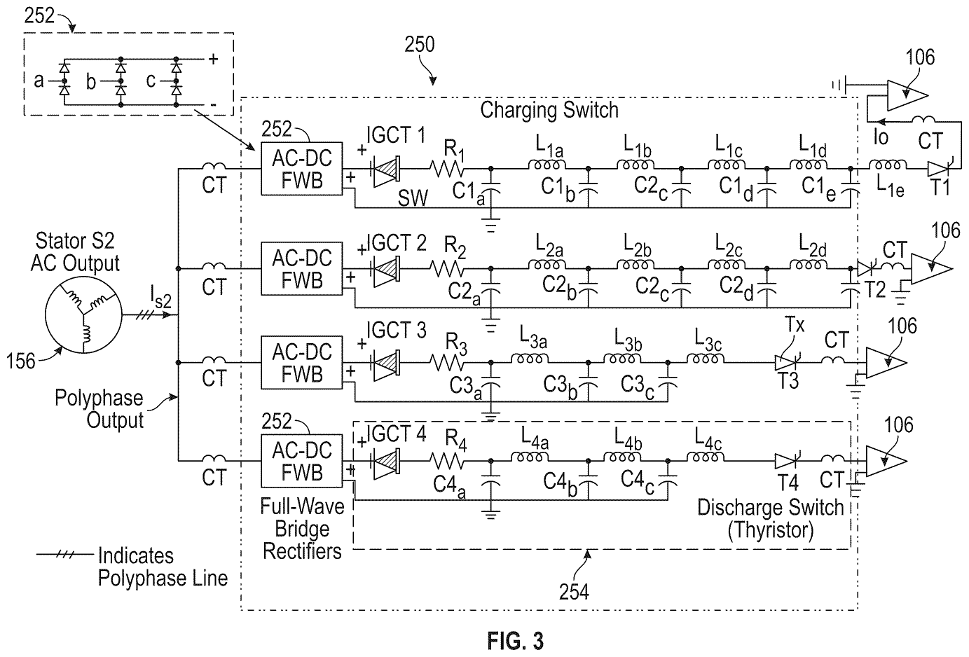

FIG. 3 depicts a power conditioning circuit configured to deliver the output current (Io) generated by the HESM electrical machine 150 to pulsed loads 106 according to a non-limiting embodiment of the present disclosure. The conditioning circuit network 250 incudes one or more conditioning branches corresponding to a respective load 106. In a non-limiting embodiment, the conditioning circuit network 250 utilizes a multi-stage configuration, where additional stages improve current flatness, ensuring a constant current output for the connected loads 106, typically as a constant-current source.

Each branch includes an AC-to-DC converter 252 and a PFN 254. The converter input is connected to an output port of the output stator 156, while the converter output is connected to the PFN 254 input. The output stator 156 generates an AC output, which is fed into multiple AC-to-DC converters 252. Each AC-to-DC converter 252 can be implemented as a full-wave bridge rectifier (FWB) that rectifies the AC signal into DC. This rectified voltage serves as the input for the PFN 254, which shapes the DC output including, but not limited to, a quasi-square, triangular or sawtooth waveshape before supplying it to various pulsed loads, such as loads 106.

Each PFN 254 includes a combination of a charging switch (SW), a resistor (Rx), inductors (Lx), capacitors (Cx), and a discharge switch (Tx). The charging switch (SW) can be implemented as an integrated gate-commutated thyristor (IGCT), for example, which facilitates controlled energy transfer into the PFN. By controlling the flow of the output current (Is2) into the PFN 254, the charging switch (SW) ensures precise energy storage in the capacitor-inductor network. When activated, the charging switch (SW) allows the rectified DC voltage to charge the capacitors (Cx) and inductors(Lx), storing energy for later controlled discharge.

The resistors (Rx) control the charging dynamics, while the inductors (Lx) and capacitors (Cx) form a resonant discharge circuit that shapes the output waveform. The discharge switch (Tx) can be implemented as a thyristor, for example, which controls current flow from the PFN 254 to the connected pulsed load 106. Once charged, each PFN 254 releases energy in a controlled manner through the switching device (Tx) to achieve precise pulse shaping. In a non-limiting embodiment, the PFN 254 can implement a multi-stage L-C circuit to deliver a quasi constant-current waveform to the pulsed load 106.

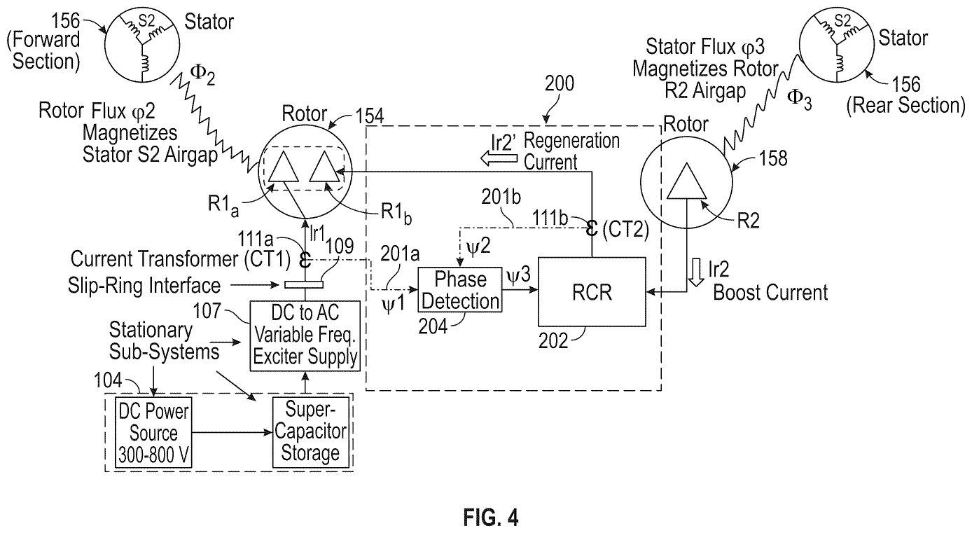

FIG. 4 illustrates the regenerative circuit 200 included in the HESM electrical machine 150 according to a non-limiting embodiment of the present disclosure. The regenerative circuit 200 includes the RCR 202, a first current transformer (CT1), a second current transformer (CT2), and a phase detection unit 204. As described herein, the regenerative circuit 200 operates to control recovered energy produced by the output stator 156 winding S2 (e.g., the rear section), and inject current back into the main rotor 154 winding R1b, which magnetizes the output stator 156 (e.g., the front section). The regeneration circuit 200 allows bidirectional flow of currents Ir2 and Ir2′ and bidirectional power flow into and out of RCR 202.

The main rotor winding (R1) receives excitation current (Ir1) through a DC-to-AC variable frequency converter 107, which receives from the exciter power supply 104 (e.g., a 300-800V DC power source and super-capacitor storage system). One or more slip rings 109 transfer the required current to the main rotor 154. The first current transformer (CT1) measures the exciter main current (Ir1), which induces the second magnetic flux (φ2), and outputs a first current feedback signal (201a) to the phase detection unit 204 to control gating signal commands to the power switching devices in the RCR 202.

The boost rotor 158 in response to the flux (φ3) from stator winding S2 generates the boost current (Ir2), which energizes and excites the boost rotor winding (R2). The RCR 202 produces and regulates the regeneration current (Ir2′) and adjusts its electrical phase angle to ensure synchronization with the excitation current (Ir1), while the second current transformer (CT2) measures the regeneration current (Ir2′) and outputs a second current feedback signal (201b) to the phase detection unit 204 of the RCR 202.

The phase detection unit 204 determines the first phase (ψ1) of the excitation current (Ir1) and the second phase (ψ2) of the regeneration current (Ir2′) and compares these two phases to maintain phase angle alignment for the output signal (ψ3) and ensure optimal energy recovery. Accordingly, the RCR 202 can actively regulate the phase of the regenerated power so that it remains in phase with the main excitation power. Regardless of shaft speed variations, the regenerative output frequency on the boost rotor winding (R2) remains constant at the same frequency as the main rotor winding (R1). This ensures stable power delivery and efficient energy conversion throughout the system.

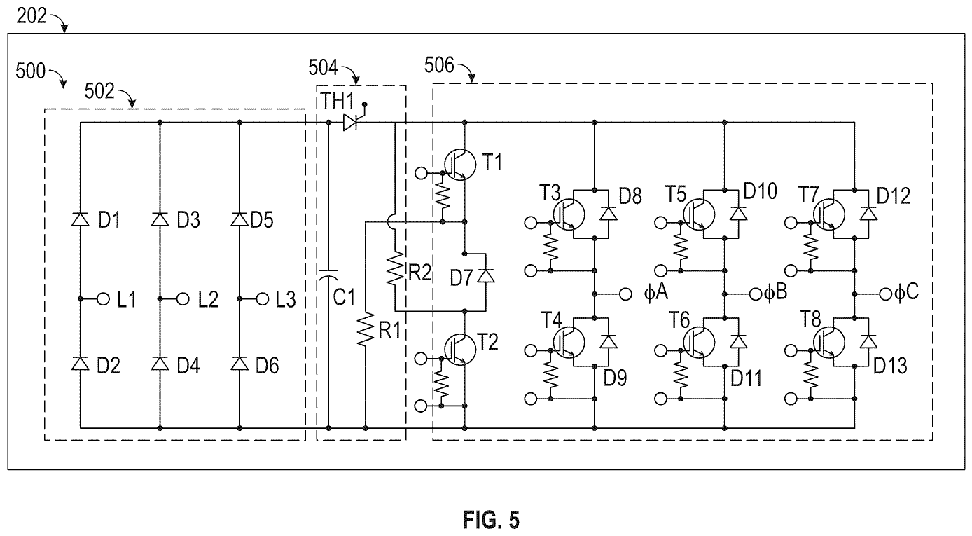

FIG. 5 is a schematic diagram of an example three-phase rectifier-inverter IGBT circuit 500 utilized in the RCR 202 according to a non-limiting embodiment of the present disclosure. The three-phase rectifier-inverter IGBT circuit 500 includes input node terminals (L1, L2, L3) configured to receive the boost current (Ir2) from the boost rotor winding (R2), and output phase terminals (φA, φB, φC) configured to produce output the regeneration current (Ir2′) hence injected to the main rotor 154 of winding R1b.

The three-phase rectifier-inverter IGBT circuit 500 processes regenerated power from the boost rotor winding (R2) and reinjects it into the rotor winding (R1b) to sustain excitation. The three-phase rectifier-inverter IGBT circuit 500 includes three stages: a rectification stage 502, a DC-link filtering stage 504, and an AC inversion stage (506). The boost rotor 158 (R2) supplies a three-phase AC output to the input terminals (L1, L2, L3) of the rectifier-inverter circuit. The rectification stage 502 includes a three-phase rectifier, formed by six diodes (D1-D6), converts the AC input into DC voltage by allowing current to flow in only one direction. Accordingly, the rectification stage 502 generates a pulsating DC voltage, which is filtered and regulated before reinjecting it into winding R1b of the main rotor 154.

The DC-link filtering stage 504 stabilizes the rectified voltage to ensure smooth and controlled power transfer. The DC-link filtering stage 504 includes a capacitor (C1), resistors (R1, R2), and a thyristor (TH1). The capacitor (C1) stores and releases energy to filter out voltage ripples, while the resistors (R1, R2) control over-voltage in conjunction with the T1 IGBT and T2 IGBT to prevent excessive voltage fluctuations. The thyristor (TH1) provides additional switching control, ensuring that the regulated DC voltage remains at an optimal level before entering the inverter stage 506.

The inverter stage 506 includes eight insulated-gate bipolar transistors (IGBTs) (T3-T8), which convert the stabilized DC voltage into a controlled three-phase AC output at terminals φA, φB, and φC. The IGBTs operate in a pulse-width modulation (PWM) switching sequence to control the output waveform′s phase, amplitude and frequency. Each IGBT (T3-T8) is paired with a freewheeling diode (D8-D13) to manage transient currents and protect the circuit from voltage spikes. Accordingly, the inverter stage 506 ensures that the regenerated power maintains synchronization with the main excitation current (Ir1) and associated frequency, optimizing energy reinjection.

The output terminals (φA, φB, and φC) deliver the regulated regeneration current (Ir2′) back into main rotor winding (R1b) to effect flux regeneration and ensure a continuous and efficient excitation process. Accordingly, the three-phase rectifier-inverter IGBT circuit 500 is capable of maintaining a constant regeneration frequency (Fr), matching the main rotor winding frequency, regardless of shaft speed variations.

Turning now to FIG. 6, is a block diagram illustrating the physical arrangement of the HESM electrical machine 150 depicted in FIG. 2 according to a non-limiting embodiment of the present disclosure. The HESM electrical machine 150 is supported by a rigid frame 117 and includes a main input stator 152, an output stator 156, and a rotatable shaft 113. Stator 152 and stator 156 are axially separated by airgap 119 and have minimal magnetic coupling except through a magnetic path of the main rotor 154. The main input stator 152 and the output stator 156 surround the rotatable shaft 113 and are separated therefrom by a first radial airgap 115 that extends along parallel to the length of the rotatable shaft 113. The rotatable shaft 113 can rotate at high speeds ranging from about 1000 rotations per minute (RPM) to about 20,000 RPM. Coupled to the shaft 113 for rotation therewith is a main rotor 154, a boost rotor 158, and a RCR 202, all of which are separated from the main input stator 152 and output stator 156 by the first radial airgap 115. The main input stator 152 is positioned around the main rotor 154, while the output stator 156 is positioned around the boost rotor 158. The RCR 202 is interposed between the main rotor 154 and the boost rotor 158 to regulate current flow and frequency therebetween as discussed in detail below.

The HESM electrical machine 150 further includes a flywheel 105, a set of bearings 110, and one or more slip rings 109, 111. The flywheel 105 is coupled to the shaft 113 and serves as an energy storage device that operates in conjunction with the exciter power supply 104, while the slip ring 109 is configured to inject secondary current from an external exciter and feed it to the winding (R1a) of the main rotor 154. The flywheel 105 coupled to the rotating shaft 113 and operates as an energy buffer to store excess mechanical energy and release it as needed to maintain a consistent rotational speed. The slip ring 109 serves as a current injector by receiving AC power from the exciter power supply 104 and can output a polyphase AC excitation current (Ir1), which is delivered to the main rotor 154 to energize and excite the main rotor winding (R1).

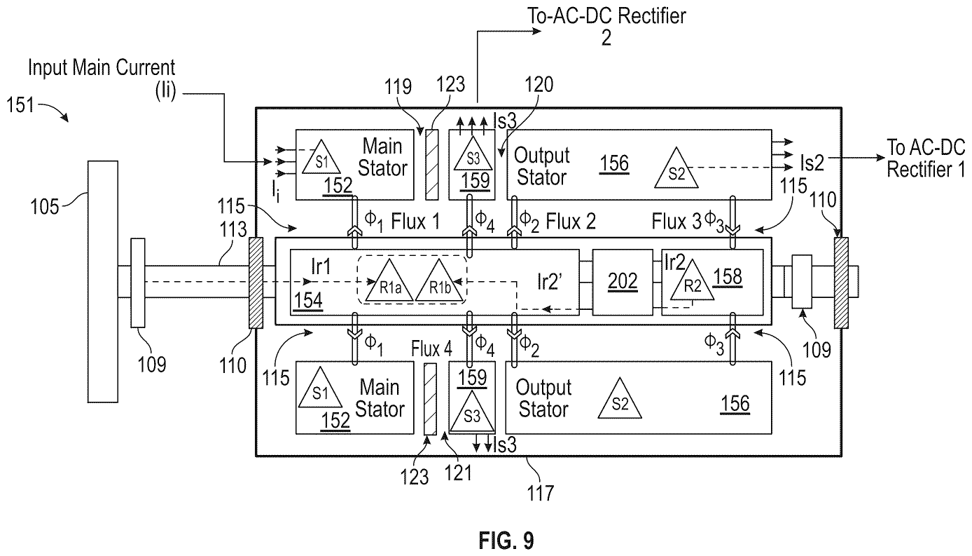

The main input stator 152 receives an input main current (Ii) delivered from a main AC power supply 102, and the main rotor 154 receives an exciter current (Ir1) output from the DC-to-AC polyphase converter 107. When the main rotor winding (R1) is excited, a first rotor flux (φ1r) is produced in the first radial airgap 115 by the main rotor 154. The magnetic flux so described herein is a radially directed flux with reference to the specific cylindrical geometry of FIGS. 6 and 9 although the concept is universal to other geometries including axial flux machines. There is also a stator flux or “armature reaction flux” (φ1s) induced in response to flow of the input main current (Ii) through the main input stator winding (S1). Accordingly, the first rotor flux interacts with stator flux to produce a first total airgap flux (φ1).

The energized main rotor 154 also produces the second magnetic flux (φ2) in a portion of the first radial airgap 115 located between the main rotor 154 and the output stator 156. This second magnetic flux (φ2) appearing in the first radial airgap 115 energizes the output stator winding (S2) and induces a current flow (Is2) therethrough. The output stator current (Is2) induced by the second radial airgap flux (φ2) can then be delivered to one or more AC-DC rectifiers to generate an output current for driving one or more of the load.

A portion of the second magnetic flux (φ2) also energizes the boost rotor 158, which produces the third flux (φ3) in another portion of the first radial airgap 115 as it rotates with the shaft 113. The third magnetic flux induces a flow of current referred to as “boost current” (Ir2) through the boost rotor winding (R2). In a non-limiting embodiment, the total magnetic fluxes (e.g., φ1, φ2, φ3) at any particular point along the axial length of the shaft 113 can be defined as a combination of the flux produced by a rotor (e.g., the main rotor 154 or the boost rotor 158) and the corresponding stator flux produced by a stator (e.g., the main input stator 152 or the output stator 156). In a non-limiting embodiment, a second set of slip rings 111 can be disposed at the end of the shaft 113. In this scenario, the second set of slip rings 111 can directly access the induced current in the boost rotor winding (R2), can monitor the induced current and allow injection of an external source of the reactive power (e.g., from a capacitor bank) to increase the power factor of the boost rotor winding (R2).

With continued reference to FIG. 6, the boost current (Ir2) is delivered to the RCR 202, which includes three-phase rectifier-inverter IGBT circuit 500 that is operable to regulate the level and frequency of boost current” (Ir2). The current output from the RCR 202 is referred to as a “regeneration current” (Ir2′), which is injected back into main rotor winding (R1b) to supplement main exciter current (Ir1) and increase the total current that is input into the main rotor 154 and therefore boost magneto-motive force (MMF) of the main rotor 154.

As described herein, the RCR 202 dynamically manages power flow and current phase, allowing energy derived in the boost rotor 158 to be regenerated back into the main rotor 154. As the current (Is2) flowing through output stator winding (S2) increases, an increase in the induced excitation of the boost rotor 158 also increases, which injects a greater amount of regeneration current (Ir2′) back into the main rotor winding R1b and increases or “boosts” the second magnetic flux (e.g., φ2) associated with the main rotor 154. Accordingly, the HESM electrical machine 150 provides an overall regenerative effect, which enhances efficiency and improves speed of response to build up the output voltage. The HESM electrical machine 150 also maximizes energy utilization through mutual flux interactions between the stators 152, 156 and the rotors 154, 158.

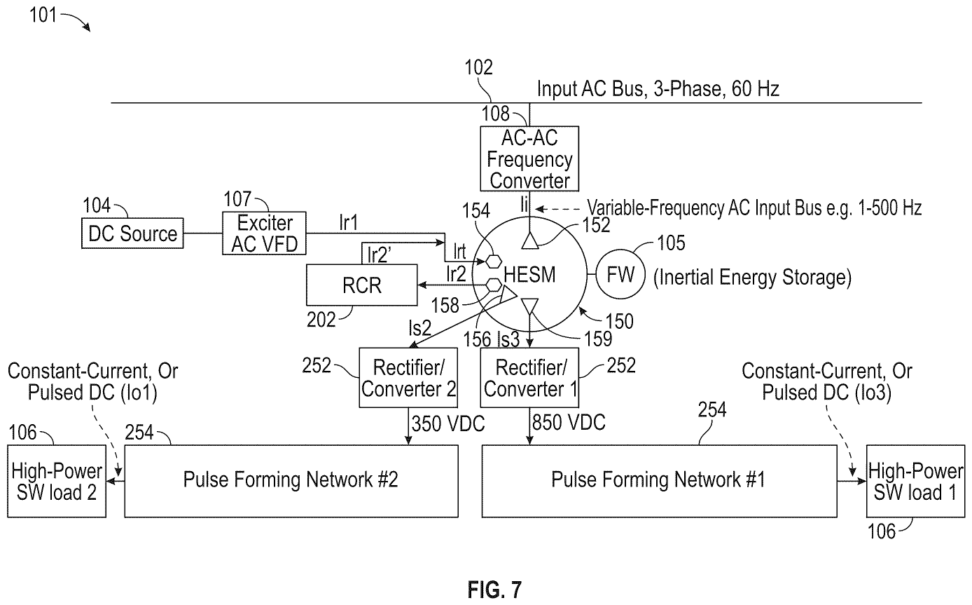

Turning now to FIG. 7, a regenerative multi-port energy storage system 101 is illustrated according to another non-limiting embodiment of the present disclosure. The regenerative multi-port energy storage system 101 operates in a similar manner as the regenerative multi-port energy storage system 100 described in FIG. 1A. Therefore, details of each component will not be repeated for the sake of brevity.

The regenerative multi-port energy storage system 101 includes a HESM electrical machine 150. The HESM electrical machine 150 includes an RCR 202. The RCR 202 utilizes the flux produced by the output stator 156 to generate a regeneration current (Ir2′). The regeneration current (Ir2′) supplements the main exciter current (Ir1) to produce higher (i.e., boosted) exciter current (Irt), which effectively regenerates the main rotor winding (R1).

The HESM electrical machine 150 further includes a main input stator 152, an output stator 156, and an additional isolated stator 159. The isolated stator 159 is configured to produce a tertiary output current (Is3), which can then be utilized to produce a second output pulsed current (Io3) that is independent and isolated from the first output pulsed current (Io1). In this manner, the second output pulsed current (Io3) can drive a separate and independent load 106 from the load 106 driven by the first output current (Io1). For example, the first load 106 driven by the first output pulsed current (Io1) can operate at a different output voltage, a different regenerate rate, and/or a different power level than the second load driven by the second output current (Io3).

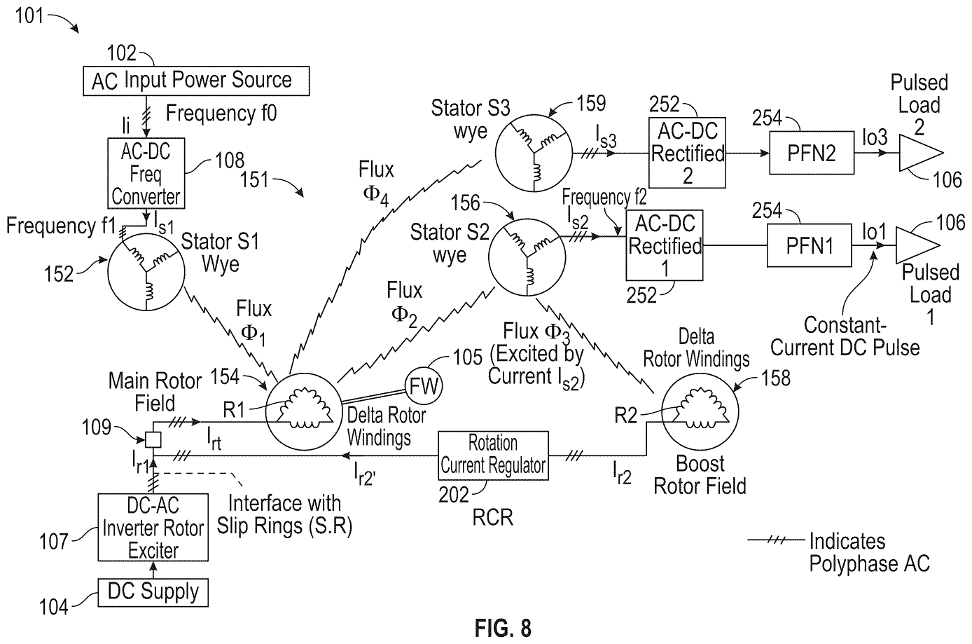

Referring to FIG. 8, a HESM electrical machine 151 implemented in the regenerative multi-port energy storage system 101 is illustrated according to another non-limiting embodiment of the present disclosure. The HESM electrical machine 151 operates in a similar manner as the HESM electrical machine 150 described in FIG. 2. Therefore, details of each component will not be repeated for the sake of brevity.

As described herein, the HESM electrical machine 151 includes an additional isolated stator 159, which facilitates a dual AC output configuration including output stator 156 and isolated stator 159. In a non-limiting embodiment, the isolated stator 159 allows the system to generate two separate AC outputs, e.g., two independent pulsed loads that can be driven by separate voltage and currents. Accordingly, each of the stator output current (Is2) and the (Is3) can independently feed a rectifier, charging switch, and PFN. Accordingly, the HESM electrical machine 151 can support dual loads via corresponding PFNs 254 (e.g., PFN1 and PFN2), each capable of operating with different current capacities, voltage levels, and time constants. Since the isolated stator 159 and output stator 156 function independently, each PFN 254 (e.g., PFN1 and PFN 2) can incorporate distinct L-C configurations, distinct rise-times and distinct fall-times tailored for its specific output pulse requirements. In a non-limiting embodiment, each PFN 254 can operate at different output voltages, different pulsed rates, and/or different power levels.

With continued reference to FIG. 8, the output stator 156 continues to serve a dual function by supplying power to its designated PFN 254, while also magnetizing the boost rotor winding (R2) of the boost rotor 158. The boost rotor 158, in turn, delivers power to the RCR 202, where it is processed and reinjected into the main rotor 154 (e.g., the main rotor winding R1).

The regeneration current (Ir2′), processed by the RCR 202, supplements by a shunt connection the main exciter current (Ir1) to enhance the total excitation current (Irt) flowing into the main field winding (R1). By increasing the combined exciter current (Irt), the HESM electrical machine 151 achieves a higher excitation current, strengthening the output of both the output stator 156 and the isolated stator 159. Accordingly, the dual-output configuration of the HESM electrical machine 151 allows different loads to operate under customized electrical conditions, while also maintaining a highly efficient regenerative energy loop.

Turning to FIG. 9, is a block diagram illustrating the physical arrangement of the HESM electrical machine 151 depicted in FIG. 8 according to a non-limiting embodiment of the present disclosure. The HESM electrical machine 151 operates in a similar manner as the HESM electrical machine 150 described in FIG. 6. Therefore, details of each component will not be repeated for the sake of brevity.

The HESM electrical machine 151 has a main radial airgap 115 that extends uniformly along a length of the main rotor 154. In a non-limiting embodiment, the isolated stator 159 is disposed between axial airgap 120 and 121 and interposed between the main input stator 152 and the output stator 156. In at least one non-limiting embodiment, a magnetic shield 123 is also disposed between the axial airgap 119 and 121, between the isolated stator 159 and the main input stator 152.

The main rotor 154 produces radially directed magnetic fluxes φ1, φ2 and φ3, as described above, but also produces an additional fourth magnetic flux (φ4). The fourth magnetic flux (φ4) interacts with the isolated stator 159 and energizes the isolated polyphase stator winding S3. The energized isolated polyphase stator winding S3 induces the tertiary output current (Is3), which can be utilized to drive a load different from the load driven using the output stator current (Is2). The loads on the output stator 156 and/or the isolated stator 159 may be steady-state or pulsed electrical loads.

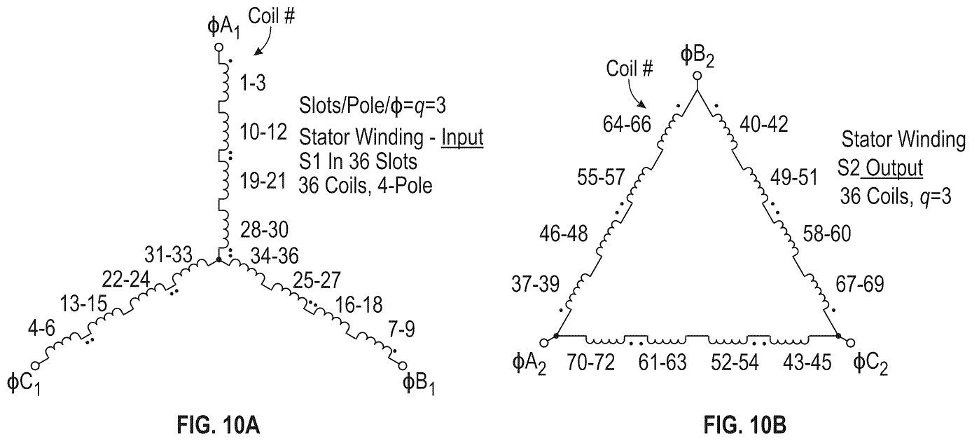

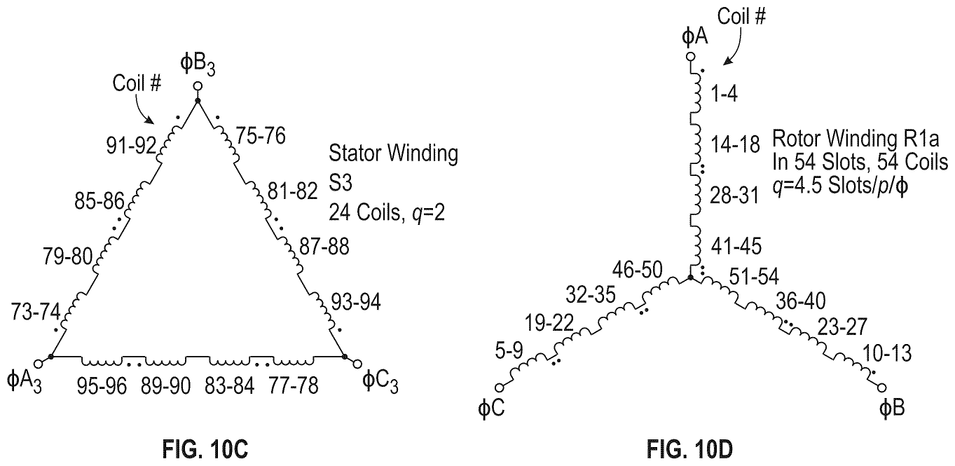

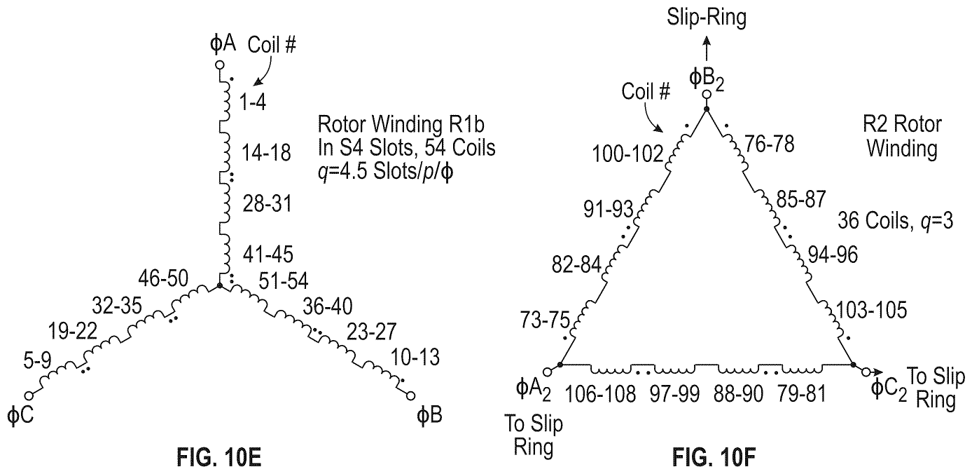

FIGS. 10A-10F depicts various windings implemented in the regenerative multi-port energy storage system 100 according to non-limiting embodiments of the present disclosure. FIGS. 10A, 10B and 10C depict polyphase winding layouts implemented on magnetic cores of the 152, 156 and 159, respectively.

FIG. 10A depicts a polyphase 4-pole winding layout of the stator winding (S1) implemented on a magnetic core of the main input stator 152. FIG. 10B depicts a polyphase winding layout of the stator winding (S2) implemented on a magnetic core of the output stator 156. FIG. 10C depicts a polyphase winding layout of the stator winding (S3) implemented on a magnetic core of the isolated stator 159. FIGS. 10D and 10E depict wye-type winding layouts of the rotor windings (R1A and R1B) implemented on a magnetic core(s) of the main rotor 154. As described herein the rotor windings (R1A and R1B) can be co-wound in a common slot formed in the main rotor 154. FIG. 10F is a polyphase delta winding layout of a rotor winding (R2) implemented on a magnetic core of boost rotor 158. The slots/pole/phase of the windings are designated as “q”. In a non-limiting embodiment, the windings can be formed as double-layer, lap-wound, or by double-layer concentric wound layouts. The winding configuration can be made for other pole numbers and slot combinations in addition to the 4-pole arrangement shown.

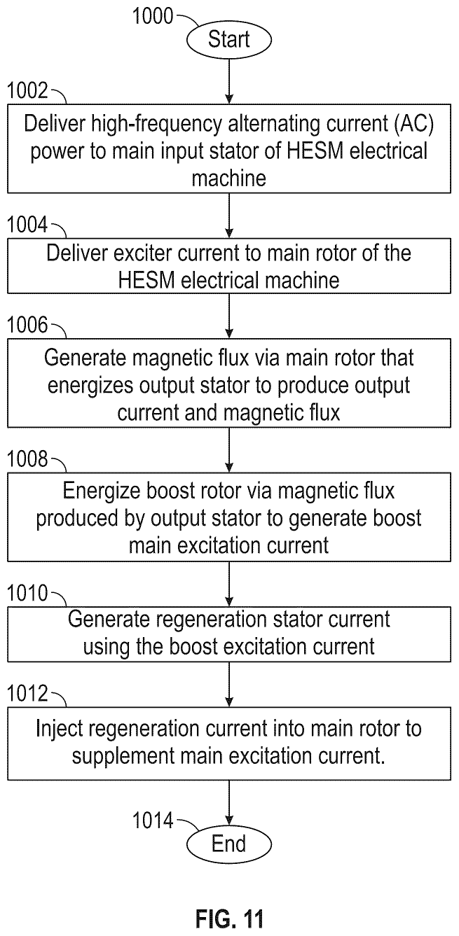

Turning now to FIG. 11, a method of operating a multi-port energy storage system is illustrated according to a non-limiting embodiment of the present disclosure. The method begins at operation 1000, and high-frequency alternating current (AC) power is delivered to a main input stator of a HESM electrical machine at operation 1002. At operation 1004, an exciter current is delivered to a main rotor of the HESM electrical machine. At operation 1006, a magnetic flux is generated via the main rotor. The magnetic flux energizes an output stator of the HESM electrical machine to produce an output current that flows through an output stator winding. At operation 1008, a boost rotor winding of the HESM electrical machine is energized via the magnetic flux produced by the output stator winding to generate a boost current. At operation 1010, a regeneration magnetic flux and current generated based on the boost current is induced in the boost rotor. At operation 1012 the regeneration current is injected into the main rotor to supplement main excitation, and the method ends at operation 1014.

As described herein, various non-limiting embodiments of the present disclosure provide a regenerative multi-port energy storage system that implements compact rotating machinery and inertial storage to buffer the multiple high-power/high-speed pulsed loads requiring high-power input generated using a main AC power supply. The regenerative multi-port energy storage system also implements compact rotating machinery and inertial storage to buffer a main AC power supply from multiple high-power/high-speed pulsed loads and repetitive transient and power surges caused by high pulse rates of the loads

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A regenerative multi-port energy storage system, comprising:
a main alternating current (AC) power supply configured to deliver AC power to a main input stator of a wound-field induction electrical machine;
a main rotor electromagnetically coupled to the main input stator and configured to be energized by an exciter power supply to generate a magnetic field that interacts with the main input stator to produce a first magnetic flux;
an inertial energy storage device mechanically coupled to the main rotor;
an output stator configured to be energized by a second magnetic flux generated from interaction between the energized main rotor and the output stator, the output stator generating an output stator current for driving an electrical load in response to being energized;
a boost rotor magnetically coupled to the output stator and configured to be energized by the second magnetic flux to generate a boost current in a boost rotor winding; and
a rotating current regulator (RCR) configured to regulate the boost current to generate a regeneration current and to inject the regeneration current into the main rotor to increase magnetic excitation and voltage of the output stator.

2. The system of claim 1, wherein the main rotor includes a main rotor winding implemented as dual-windings comprising a first winding (R1a) and a second winding (R1b).

3. The system of claim 2, wherein the rotating current regulator (RCR) is configured to inject the regeneration current into the second winding (R1b) of the main rotor.

4. The system of claim 3, wherein the RCR comprises a switching circuit configured to regulate a level and a frequency of the boost current.

5. The system of claim 4, wherein the switching circuit comprises a rectification stage, a DC-link filtering stage, and an inverter stage.

6. The system of claim 5, wherein the inverter stage comprises a plurality of insulated-gate bipolar transistors (IGBTs) configured to operate in a pulse-width modulation (PWM) sequence to control a phase and frequency of the regeneration current.

7. The system of claim 6, further comprising a pulse forming network (PFN) configured to condition the DC output power from the AC-to-DC converter to produce a flat-top or constant-current waveform for delivery of power to a high-power pulsed load.

8. A regenerative multi-port energy storage system, comprising:
a main rotor configured to be energized by an exciter power supply and to produce a magnetic field that interacts with a main input stator to generate a first magnetic flux;
an output stator configured to be energized by a second magnetic flux produced from interaction between the energized main rotor and the output stator, the output stator generating an output stator current (Is2);
a boost rotor magnetically coupled to the output stator by a third magnetic flux and configured to generate a boost current (Ir2) in a boost rotor winding (R2); and
a rotating current regulator (RCR) configured to regulate the boost current (Ir2) to produce a regeneration current (Ir2′) that is injected into the main rotor to supplement a main exciter current (Ir1); and
an isolated stator configured to be energized by a fourth magnetic flux produced by the main rotor and to generate a tertiary output current (Is3) that is electrically isolated from the output stator current (Is2); and
an inertial energy storage device mechanically coupled to the main rotor.

9. The regenerative multi-port energy storage system of claim 8, further comprising:
a first pulse forming network (PFN1) configured to receive the output stator current (Is2) and deliver a first pulsed output current (Io1); and
a second pulse forming network (PFN2) configured to receive the tertiary output current (Is3) and deliver a second pulsed output current (Io3) that is electrically isolated from the first pulsed output current.

10. The system of claim 9, wherein the main rotor includes a main rotor winding implemented as dual-windings comprising a first winding (R1a) and a second winding (R1b), and wherein the regeneration current (Ir2′) is injected into the second winding (R1b).

11. The system of claim 10, wherein the RCR comprises a switching circuit located on the rotor and configured to regulate a level and a frequency of the boost current (Ir2).

12. The system of claim 11, wherein the switching circuit is a three-phase rectifier-inverter power-semiconductor switching circuit which includes a rectification stage, a DC-link filtering stage, and an inverter stage capable of regulating frequency, phase angle and amplitude of the regeneration current Ir2′.

13. The system of claim 12, wherein the inverter stage comprises insulated-gate bipolar transistors (IGBTs) configured to operate in a pulse-width modulation (PWM) sequence to control a phase, amplitude and frequency of the regeneration current (Ir2′).

14. The system of claim 13, wherein the output stator current (Is2) energizes the boost rotor and the boost rotor delivers the boost current (Ir2) to the RCR.

15. A method of operating a multi-port energy storage system, the method comprising:
delivering, from a main AC power supply, an alternating current (AC) power input to a main input stator of a wound-field induction electrical machine;
energizing a main rotor of the wound-field induction electrical machine using an exciter power supply to generate a magneto-motive force and develop a magnetic field that interacts with the main input stator to produce a first magnetic flux;
generating a second magnetic flux from an interaction between the energized main rotor and an output stator of the induction electrical machine, the second magnetic flux energizing the output stator to generate a first output stator current;
energizing a boost rotor magnetically coupled to the output stator using a third magnetic flux to induce a boost current in a boost rotor winding;
generating, using a rotating current regulator (RCR), a regeneration current based on the boost current;
injecting the regeneration current into the main rotor to increase magnetic excitation and induced voltage in the output stator, and
energizing an isolated stator by a fourth magnetic flux generated by at least one rotor winding.

16. The method of claim 15, wherein energizing the main rotor includes energizing a first rotor winding (R1a) included with the main rotor and a second rotor winding (R1b) included with the main rotor.

17. The method of claim 16, wherein injecting the regeneration current includes injecting the regeneration current into the second rotor winding (R1b).

18. The method of claim 17, further comprising powering a pulsed load using the isolated stator that includes an isolated stator winding (S3), the isolated stator winding (S3) utilizing a separate magnetic flux from the second rotor winding (R1b) to generate an output a second output stator current independent of the first output stator current.

19. The method of claim 18, further comprising controlling a phase and frequency of the regeneration current to regulate the magnetic excitation of the output stator, wherein the regeneration current and its power flow are bidirectional.

20. The method of claim 18, further comprising driving at least one load using one or both of the output stator and the isolated stator.
